(19) United States
(12) Patent Application Publication
(10) Pub. No.: US 2023/0036594 A1
(43) Pub. Date: Feb. 2, 2023

(54) Interchangeable and Dual-Functional Robot

(71) Applicants: Kyle OUYANG, Pleasanton, CA (US); William OUYANG, Pleasanton, CA (US)

(72) Inventors: Kyle OUYANG, Pleasanton, CA (US); William OUYANG, Pleasanton, CA (US)

(21) Appl. No.: 17/849,633

(22) Filed: Jun. 25, 2022

Related U.S. Application Data
(60) Provisional application No. 63/228,360, filed on Aug. 2, 2021.

(51) Int. Cl. A01D 34/00

(52) U.S. Cl. CPC A01D 34/008; A01D 2101/00

(57) ABSTRACT

An interchangeable and dual-functional robot is disclosed. The robot includes a portable electronic box to couple or uncouple with the lawn mower body. When the portable electronic box is in the recess of the lawn mower body, the portable electronic box connects to the mechanical and electronic components of the lawn mower body such that the coupled system functions as a robotic lawn mower. When the portable electronic box is taken out of the lawn mower body, the portable electronic box couples with a surveillance camera module to function as a mobile surveillance system. The portable electronic box may couple with a mobile cart or individual wheels to function as a mobile surveillance system.

### CROSS-REFERENCE TO RELATED APPLICATIONS

The present application claims the priority of U.S. Provisional Application No. 63/228,360 which is filed on Aug. 2, 2021.

### BACKGROUND OF THE INVENTION

### 1. Field of the Invention

The invention relates to a robot which is dual-functional and interchangeable in functioning as a robotic lawn mower or a mobile surveillance system. When a portable electronic box is placed inside the lawn mower body, the robot functions as the robotic lawn mower. When the portable electronic box is taken outside of the lawn mower body, it couples with a surveillance camera module to function as the mobile surveillance system.

### 2. Background

People use robots to do all kinds of work to save time, money, energy, as well as for accuracy, speed, convenience, and safety reasons. For example, a robotic floor vacuum cleans the floor of the house, a robotic lawn mower cuts the lawn grass, a mobile security robot does surveillance, and a robotic pool cleaner cleans the pool. To use the robots, users may set the working times and the frequencies of robots according to their schedules and needs. These robots are usually operated at specific regions, and the robots are not interchangeable of performing different tasks at different places because of the differences in design, structure, configuration, and function. For example, for the indoor floor cleaning robot, the region is the indoor floor. For a pool cleaning robot, the region is the pool. For the robotic lawn mower, the region is the lawn.

With the rapid developments of technologies, traditional consumer products with only one function are no longer desirable. Consumers tend to prefer multipurpose goods which can sustain long term use and are capable of doing multiple tasks. Consumers may rather invest more capital in a product that can be used for a variety of purposes than one with only a single purpose. Products that have multiple functions are preferred because they are versatile, conserve resources, and are more environment friendly.

The lawn mower and mobile surveillance robot are two popular products which have been used at residential houses and industrial buildings. However, a product which can perform both lawn mowing and surveillance is not available. The proposed invention integrates the lawn mower and the mobile surveillance robot into an advanced product. The core of the disclosure is a portable electronic box to be used for both lawn mowing and mobile surveillance. This portable electronic box has dual functions and is interchangeable in doing either grass cutting or mobile surveillance. The portable electronic box can be easily plugged in or out of the lawn mower body. In one embodiment, the disclosure increases not only the functionalities of the robots, but it is also more environment friendly as there is no need to consume more raw materials in manufacturing. In summary, this disclosure proposes a dual-functional and interchangeable robot which is able to function as a robotic lawn mower and as a mobile surveillance system.

### SUMMARY OF THE INVENTION

This application discloses a dual-functional and interchangeable robot to function as a robotic lawn mower or a mobile surveillance system.

In one preferred embodiment, the dual-functional and interchangeable robot includes the following:

a robotic lawn mower body that includes a blade motor, a grass cutting blade and a mower circuit board;

a portable electronic box that includes a battery, a plurality of wheel motors and a box circuit board; and

a surveillance camera module that includes a surveillance camera.

The robotic lawn mower body includes a recess to accommodate the portable electronic box, when the portable electronic box is in the recess of the robotic lawn mower body, the portable electronic box couples with the robotic lawn mower body to function as a robotic lawn mower. When the portable electronic box is taken out of the robotic lawn mower body, the portable electronic box couples with the surveillance camera module to function as a mobile surveillance system.

In one preferred embodiment, when the portable electronic box is in the recess of the lawn mower body, the robotic lawn mower body includes a fastener structure to couple with a matched fastener structure on the portable electronic box, a mower locking structure to couple with a box locking structure on the portable electronic box, or a magnet to couple with another magnet on the portable electronic box, such that when the portable electronic box is in the recess of the robotic lawn mower body, the portable electronic box is aligned, locked, and settled with the robotic lawn mower body mechanically;

wherein when the portable electronic box is in the recess of the lawn mower body, the robotic lawn mower body includes a box electrical connector to couple with a mower body electrical connector on the lawn mower body electrically; and

wherein the portable electronic box couples with the lawn mower body mechanically and electrically to function as the robotic lawn mower.

In one preferred embodiment, when the portable electronic box is taken out the lawn mower body, the portable electronic box includes a box camera connector to couple and connect with a camera module connector on the surveillance camera module, a box electrical connector to couple and connect with a mower body electrical connector such that the portable electronic box couples with the surveillance camera module mechanically and electrically to function as the mobile surveillance system.

In one preferred embodiment, when the portable electronic box is taken out of the robotic lawn mower body, the portable electronic box couples with a mobile wheel cart and the surveillance camera module to function as the mobile surveillance system. The mobile wheel cart includes a plurality of wheels.

In one preferred embodiment, the dual-functional and interchangeable robot further includes a plurality of box wheels. The plurality of wheel motors in the portable electronic box include a plurality of shafts, each to couple with one of the plurality of box wheels with a set screw. The set screw is used to couple with the plurality of shafts of wheel motor to the plurality of the plurality of box wheels. The portable electronic box, the surveillance camera module, and the plurality of box wheels are coupled together to function as the mobile surveillance system.

In one preferred embodiment, the dual-functional and interchangeable robot further includes a plurality of box wheels. The plurality of wheel motors in the portable electronic box include a plurality of female locking structures, each to lock with a male structure on one of the plurality of box wheels, the roles of the male and female structures on the lock structures of the portable electronic box and the plurality of box wheels are interchangeable. The portable electronic box, the surveillance camera module, and the plurality of box wheels are coupled together to function as the mobile surveillance system.

In one preferred embodiment, the dual-functional and interchangeable robot further includes a plurality of box wheels. The plurality of wheel motors in the portable electronic box couples with each of the plurality of box wheels with a lock pin. The portable electronic box, the surveillance camera module, and the plurality of box wheels are coupled together to function as the mobile surveillance system.

In one preferred embodiment, the portable electronic box couples with a plurality of box wheels placed in the robotic lawn mower body such that when the portable electronic box is taken out the lawn mower body, the portable electronic box does not need other wheels to function as the mobile surveillance system.

In one preferred embodiment, the portable electronic box includes a CPU or microcontroller on the box circuit board. When the portable electronic box is in the recess of the lawn mower body, the CPU or microcontroller couples with electronic components on a mower circuit board in the lawn mower body to control the moving of the robotic lawn mower and the blade motor. When the portable electronic box is taken out of the lawn mower body, the portable electronic box couples with the surveillance camera module to function as the mobile surveillance system, the CPU or microcontroller on the box circuit board in the portable electronic box controls the moving of the mobile surveillance system and the viewing angle of the surveillance camera. The CPU or microcontroller is dual-functional in the controlling of the robotic lawn mower and the mobile surveillance system.

In one preferred embodiment, the surveillance camera module coupled with the CPU or microcontroller on the box circuit board in the portable electronic box implements an advanced computer vision technology to take images or videos of a ground to analyze and collect the information of color, texture, pattern, structure, temperature, reflectivity, light emission, and grass height, to differentiate the grass and non-grass areas, and to determine a moving route and a mowing way.

### BRIEF DESCRIPTION OF THE DRAWINGS

A better understanding of the present invention may be obtained when the following detailed description is considered in conjunction with the following drawings, in which:

FIG. 1 illustrates a typical robotic lawn mower which includes a lawn mower body, a lawn mower cover, wheels, and a control panel on top of the lawn mower cover.

FIG. 2 illustrates a robotic lawn mower with a grass cutting blade at its bottom.

FIG. 3 illustrates the components of wheel motors, blade motor, battery, and circuit boards placed inside a lawn mower body.

FIG. 4 illustrates the components of wheel motors, blade motor, battery, and circuit boards placed inside a lawn mower body.

FIG. 5 illustrates a portable electronic box to be coupled with a robotic lawn mower body.

FIG. 6 illustrates a portable electronic box coupled with a robotic lawn mower body.

FIG. 7 illustrates a portable electronic box to be coupled with a lawn mower body.

FIG. 8 illustrates a portable electronic box to be coupled with a lawn mower body.

FIG. 9 illustrates a locking structure used to lock and couple the portable electronic box with the lawn mower body.

FIG. 10 illustrates a locking structure used to lock and couple the portable electronic box with the lawn mower body.

FIG. 11 illustrates a locking structure used to lock the portable electronic box with the lawn mower body.

FIG. 12 illustrates a locking structure used to lock the portable electronic box with the lawn mower body.

FIG. 13 illustrates magnets used to lock and couple the portable electronic box with the lawn mower body.

FIG. 14 illustrates magnets used to lock and couple the portable electronic box with the lawn mower body.

FIG. 15 illustrates the coupling of a shaft of wheel motor with an individual wheel.

FIG. 16 illustrates a mobile surveillance system including a surveillance camera module, a portable electronic box, and a mobile wheel cart.

FIG. 17 illustrates a mobile surveillance system including a surveillance camera module, a portable electronic box, and a mobile wheel cart.

FIG. 18 illustrates a mobile surveillance system including a surveillance camera module, a portable electronic box, and a mobile wheel cart.

FIG. 19 illustrates an individual wheel coupled with the shaft of wheel motor inside the portable electronic box with a set screw.

FIG. 20 illustrates an individual wheel coupled with the shaft of wheel motor inside the portable electronic box with a set screw.

FIG. 21 illustrates a plurality of individual wheels coupled with the shaft of wheel motors inside the portable electronic box with set screws.

FIG. 22 illustrates a male locking structure on an individual wheel pressed and locked with a female locking structure on the shaft of the wheel motor inside the portable electronic box.

FIG. 23 illustrates a male locking structure on an individual wheel pressed and locked with a female locking structure on the shaft of the wheel motor inside the portable electronic box.

FIG. 24 illustrates an individual wheel coupled with the shaft of wheel motor inside the portable electronic box with a lock pin.

FIG. 25 illustrates an individual wheel coupled with the shaft of wheel motor inside the portable electronic box with a lock pin.

FIG. 26 illustrates a surveillance camera module.

FIG. 27 illustrates a surveillance camera module coupled with a portable electronic box.

FIG. 28 illustrates a surveillance camera module coupled with the robotic lawn mower.

FIG. 29 illustrates a plurality of box wheels coupled with the portable electronic box placed inside the lawn mower body.

FIG. 30 illustrates a plurality of box wheels coupled with the portable electronic box to function as a mobile surveillance system.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims. Furthermore, note that the word “may” is used throughout this application in a permissive sense (i.e., having the potential to, being able to), not a mandatory sense (i.e., must). The term “include”, and derivations thereof, mean “including, but not limited to”. The term “coupled” means “directly or indirectly connected”.

### DETAILED DESCRIPTION OF THE INVENTION

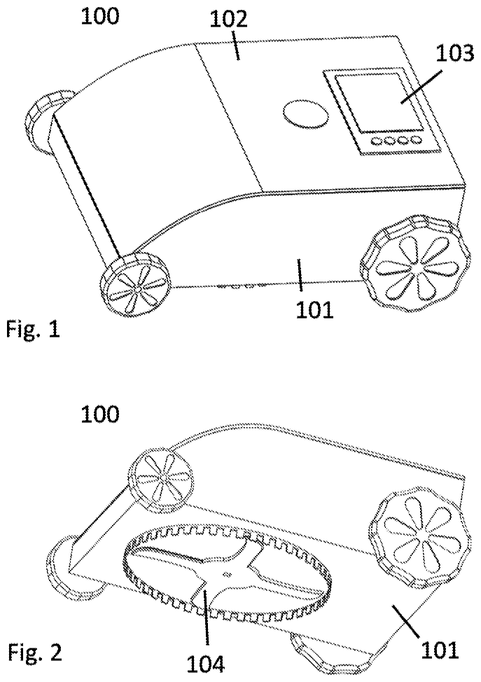

With the developments of advanced electronic devices, people use more and more electronic gears to do the routine work, such as a robotic vacuum cleans the indoor floor of the house, a robotic lawn mower cuts the lawn grass outdoors, a gutter cleaning robot blasts away leaves inside the gutter, and a pool cleaning robot cleans the pool. A typical robotic lawn mower 100, as shown in FIG. 1 and FIG. 2, usually has a lawn mower body 101 to enclose the electronic components inside, a mower cover 102 to cover the lawn mower body 101 to prevent the dust from going inside the mower and to protect the internal electronic components, a control panel 103 on the mower cover 102 for users to set the operational conditions, and a grass cutting blade 104 at its bottom.

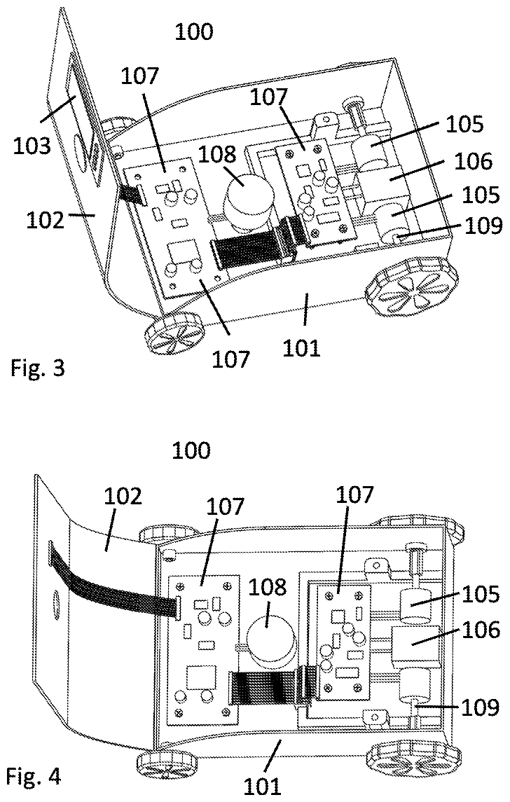

Some typical electronic components inside the lawn mower body 101 are shown in the FIG. 3 and FIG. 4, and they are battery 106, wheel motors 105, grass cutting motor 108, and one or more than one mower circuit board 107. In general, there are two wheel motors 105 to drive the moving of robotic lawn mower 100, and there are two other wheels not connecting to motors because they are only used to support the lawn mower body 101. One or more than one mower circuit board 107 is connected to the wheel motors 105, battery 106, blade motor 108, and control panel 103. In the figures, the wheel motor 105 is connected to the external wheel with a motor shaft 109. The microcontroller, CPU, sensing circuits, and various electronic components are on the mower circuit boards 107 to control the moving and rotation of the robotic lawn mower 100 and to detect the environmental conditions. The wireless IC, radio and WIFI modules, CPU or microcontroller, touch sensor, pressure sensor, rain sensor, distance sensor, inductive sensor, and all kinds of sensors may be built on the mower circuit boards 107, lawn mower body 101, or lawn mower cover 102 to make the robotic lawn mower 100 very versatile and have various functions. All the electronic components, circuit boards, and sensors are connected to each other with either wires, ribbon cables, circuit board traces, or electrical connectors.

There are various designs of robotic lawn mower 100, and the placements of the electronic components inside the mower may be not same among different brands of mowers. Regardless of the differences in designs, as long as the components are connected with either wires, ribbon cables, circuit board traces, or electrical connectors, the grass cutting work will be not affected because these electronic components are specifically designed for the grass cutting work. However, the typical mowers are designed only for grass cutting work and they are not capable of doing other work. For example, a mower cannot clean the house's indoor floor or become an indoor surveillance robot. The reasons are due to the differences in the designs of electronic circuits, product configuration, structure, shape, operational mechanisms, and other factors. In another word, the robot is not usable or interchangeable when the conditions of applications are different.

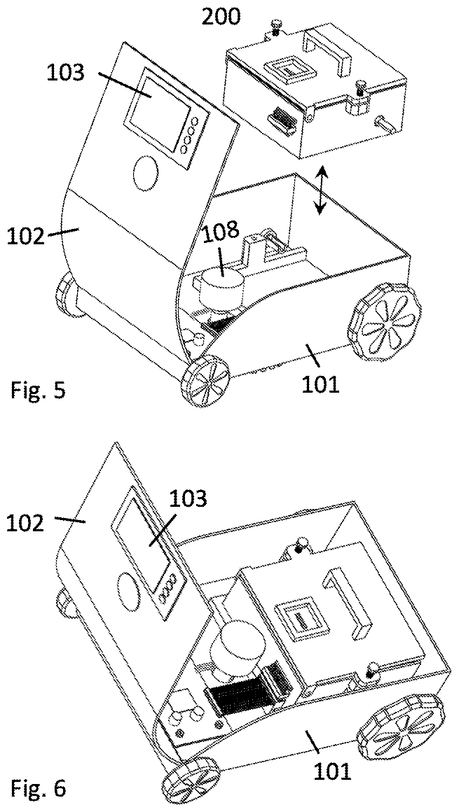

From users' perspective, a robot which can do both the grass cutting and home surveillance will be greatly desired. In this regard, present disclosure is to address this need. The disclosure proposes a novice robot which is interchangeable and dual-functional in doing both yard maintenance and home surveillance, and the concept is illustrated in FIG. 5 and FIG. 6. In the figures, a portable electronic box 200 is used to enable dual and interchangeable functions. In one embodiment, there is a recess inside the lawn mower body 101 to accommodate the portable electronic box 200. The portable electronic box 200 may be plugged in or out of the recess of the lawn mower body 101. The lawn mower body 101 here refers to a mower body frame to accommodate the portable electronic box 200. The lawn mower body 101 may include other mechanical and electrical components which are not inside the portable electronic box 200. The mechanical and electrical components outside of the portable electronic box are mainly for the grass cutting work and they may not need to be placed inside the portable electronic box 200. In one embodiment, when the portable electronic box 200 is placed in the recess of the lawn mower body 101 and is coupled with other mechanical and electrical components of the lawn mower body 101, a robotic lawn mower 100 is ready to do the yard work.

When the portable electronic box 200 is placed in the recess of the lawn mower body 101, the electronic components inside the portable electronic box 200 couple with other electronic components inside the lawn mower body 101 such that the portable electronic box 200 is a part of the robotic lawn mower 100 to do the yard work. In one embodiment, the electronic components inside the portable electronic box 200 are designed to do and control the yard work. When the portable electronic box 200 is taken out the lawn mower body 101, the portable electronic box 200 is ready for a surveillance robot. The electronic components inside the portable electronic box 200 are also designed for a mobile surveillance system 500. In one embodiment, the portable electronic box 200 has electronic components to support the robot to function both as the robotic lawn mower 100 and as the mobile surveillance system 500. In one embodiment, the portable electronic box 200 does not need to include some electronic components that are specifically for the lawn work. For example, the portable electronic box 200 does not need to include a motor for grass cutting blade 104 or a sensor specifically only for grass cutting. In one embodiment, the electronic box 200 has core electronic components for both the robotic lawn mower 100 and the mobile surveillance system 500. For example, the portable electronic box 200 may have a CPU or microcontroller to control either the robotic lawn mower 100 or the mobile surveillance system 500. For practical application, the portable electronic box 200 may have a battery 106, wheel motors 105, and a box circuit board 107 since these components are needed for both the robotic lawn mower 100 and the mobile surveillance system 500. With the same battery 106 and wheel motors 105, there is no need to have another set of battery or motors. In one embodiment, the battery 106 and the wheel motors may be placed inside the lawn mower body 101 but outside the portable electronic box 200, then there is a need to have another set of battery and wheel motors for the mobile surveillance system 500.

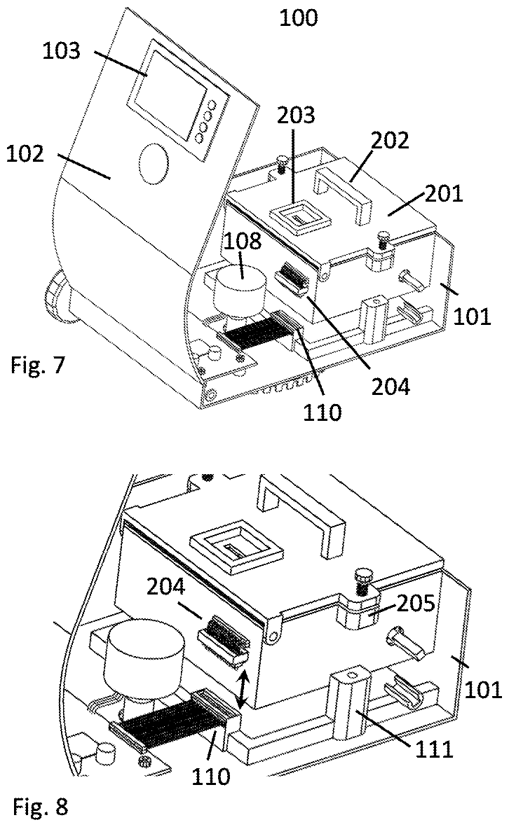

To better explain the novelty of the interchangeable and dual-functional robot, FIG. 7 and FIG. 8 illustrate an internal view of the robotic lawn mower 100 which includes the portable electronic box 200, the lawn mower body 101, and other components. The portable electronic box 200 may have a portable box cover 201, a handle 202, and a box camera connector 203 on top of the portable electronic box 200. The handle 202 is for users to plug in or plug out of the portable electronic box 200 easily. The box camera connector 203 is to connect the electronic components inside the portable electronic box 200 with the surveillance camera module 400. In one embodiment, when the portable electronic box 200 is placed in the recess of the lawn mower body 101, the portable electronic box 200 and lawn mower body 101 are connected and locked with each other mechanically and electrically. A box electrical connector 204 on the portable electronic box 200 may be used to couple with a mower electrical connector 110 on the lawn mower body 101. The electrical connectors may be a press and lock device to make it very easy for the portable electronic box 200 to connect or disconnect with the electronic devices of the lawn mower body. In addition to the electrical coupling, a mechanical structure or component on portable electronic box 200 may be used to couple and to lock with a mechanical structure or component on the lawn mower body 101. In one embodiment, the mechanical structure or component on the portable electronic box 200 may be a box fastener structure 205, and the mechanical structure or component on the lawn mower body 101 may be a mower body fastener structure 111. The fastener structure may be a screw, a bolt, a thread-hole structure or component. The fasteners are to couple and lock the portable electronic box 200 with the lawn mower body 101.

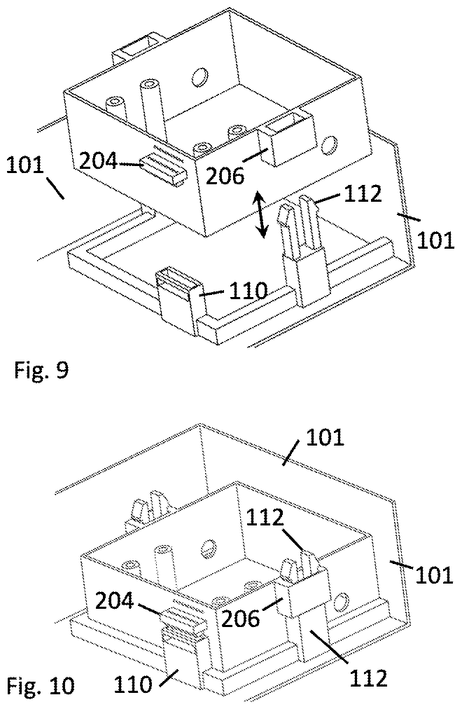

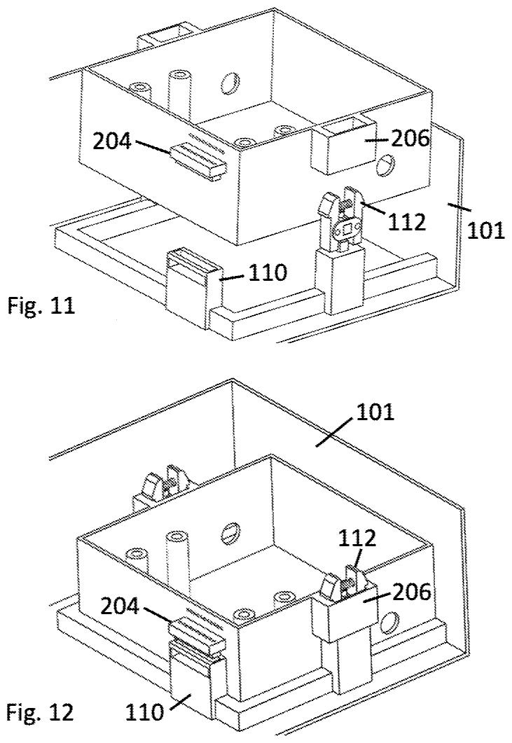

In FIG. 9 and FIG. 10, the coupling mechanical structures on portable electronic box 200 and lawn mower body 101 may use a press and lock mechanism. FIG. 9 illustrates a portion of portable electronic box 200 has a box locking structure 206 and a portion of the lawn body has a mower body locking structure 112. In one embodiment, the box locking structure 206 and mower body locking structure 112 may be called the male or female locking structure. As the portable electronic box 200 is pressed into the recess of the lawn mower body 101, the portable electronic box 200 and lawn mower body 101 are coupled and locked with each other with male and female locking structures. In one embodiment, the roles of male and female structures on the portable electronic box 200 and lawn mower body 101 may be exchanged. FIG. 11 and FIG. 12 illustrate another more sophisticated press and lock mechanism using a spring, and other components.

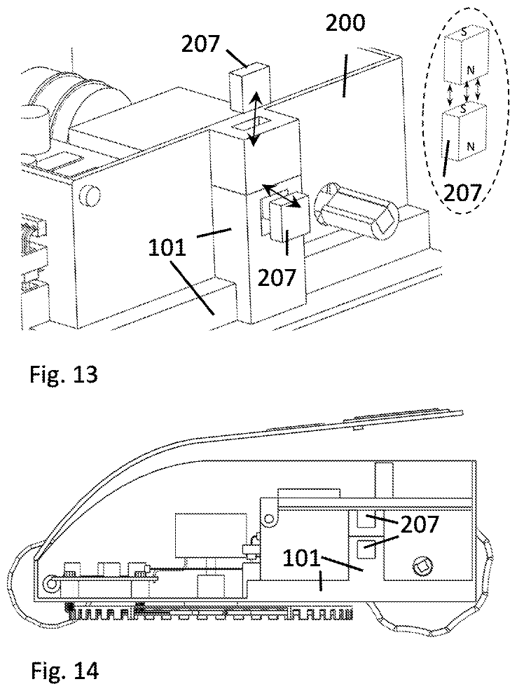

In one embodiment, various locking and coupling mechanisms may be used to couple and lock the portable electronic box 200 with the lawn mower body 101. In FIG. 13, a magnet 207 is used to align and lock the portable electronic box 200 with the lawn mower body 101. One piece of magnet 207 is attached to the portable electronic box 200 and another piece of magnet 207 is attached to the lawn mower body 101. The two pieces of magnets may be attracted to each other as illustrated in the figure. The placement of magnets 207 is flexible such as at the side or at the bottom of portable electronic box 200. FIG. 14 illustrates one example of the placement of magnets on the portable electronic box 200 and lawn mower body 101.

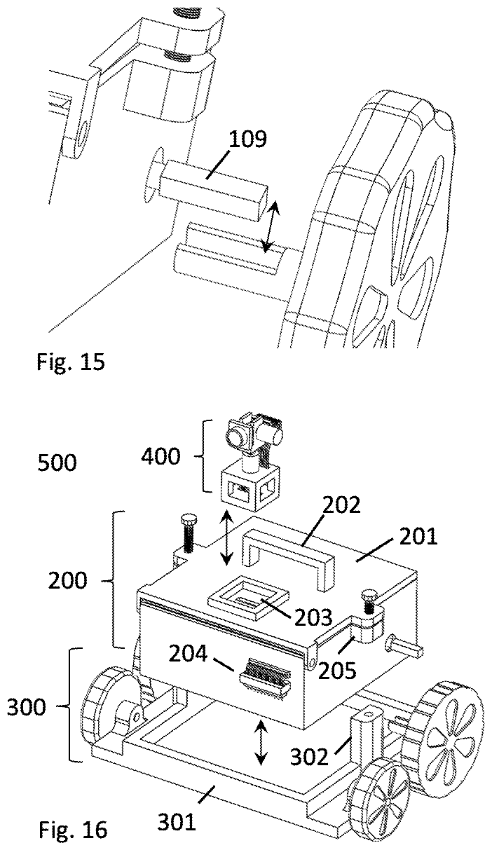

FIG. 15 illustrates the coupling of the wheel motor shaft 109 with a wheel of the robotic lawn mower 100. In one embodiment, the wheel of the robotic lawn mower 100 may have a recess, a hole, a slot, or a gear structure, such that when the portable electronic box 200 is placed inside the lawn mower body 101, the wheel motor shaft 109 goes in the recess, hole, slot, or gear structure to couple and lock with the wheel of the robotic lawn mower 100. The coupling of wheel motor shaft 109 of the portable electronic box 200 with the wheel of the robotic lawn mower 100 provides a mechanism for all components to be placed together to function as robotic lawn mower 100.

To achieve dual and interchangeable functions in doing both the grass cutting and mobile surveillance, the portable electronic box 200 is attached to or detached from the lawn mower body 101 easily. The portable electronic box 200 has electronic components to function as a standalone mobile surveillance system 500. In one embodiment, the wheels for the robot lawn mower 100 may be used for the mobile surveillance system 500. However, the lawn mowers are meant to be used outdoors and on lawns, thus their wheels get dirty easily and they cannot be brought indoors without cleaning. In one embodiment, the portable electronic box 200 may couple with another set of wheels to perform the surveillance work indoors. The coupling of another set of wheels makes it much more convenient to switch the functions of the robot for different works. In one embodiment, the mobile surveillance system 500 includes a surveillance camera module 400, a portable electronic box 200, and a mobile wheel cart 300, as shown in FIG. 16. The mobile wheel cart 300 may include a base 301 and a few wheels to support and accommodate the portable electronic box 200. The base of wheel car 301 is similar to the base of the lawn mower body 101. They are to support and accommodate the portable electronic box 200.

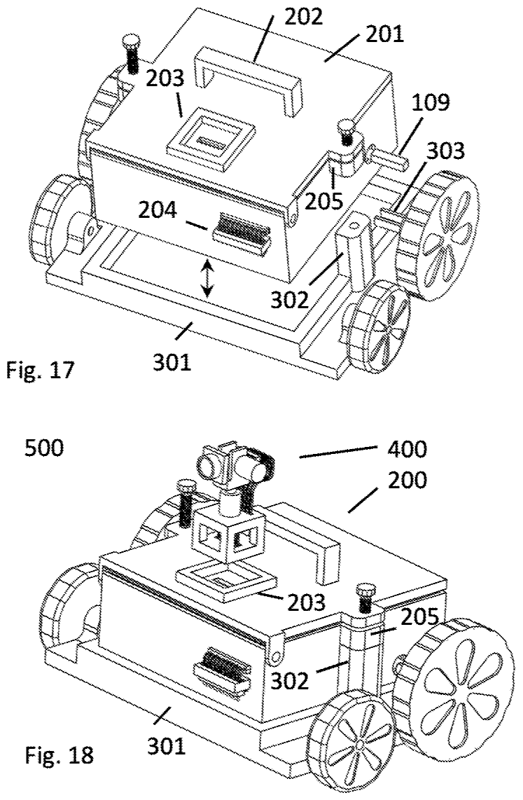

Similar to the coupling in between the robotic lawn mower 100 and the portable electronic box 200, the mobile wheel cart 300 may have various mechanisms to couple with the portable electronic box 200. In one embodiment, the mobile wheel cart 300 couples with the portable electronic box 200 with magnets 207 as shown in FIG. 13. The mobile wheel cart 300 may also couple with the portable electronic box 200 with a press-and-lock structures, as shown in FIG. 9, FIG. 10, FIG. 11, and FIG. 12. In another embodiment, the mobile wheel cart 300 may have a cart fastener structure 302 to couple with the box fastener structure 205 on the portable electronic box 200, as shown in FIG. 16, FIG. 17 and FIG. 18. The roles of cart fastener structure 302 and box fastener structure 205 may be exchanged on the mobile wheel cart 300 and on the portable electronic box 200.

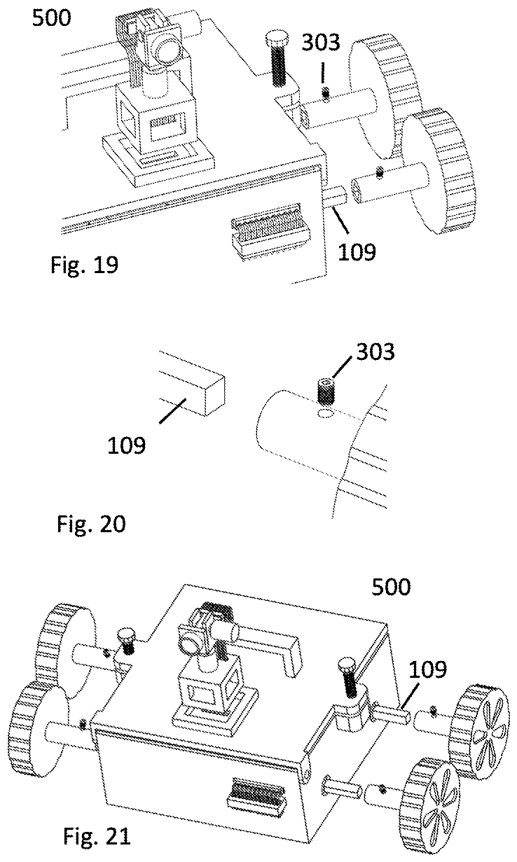

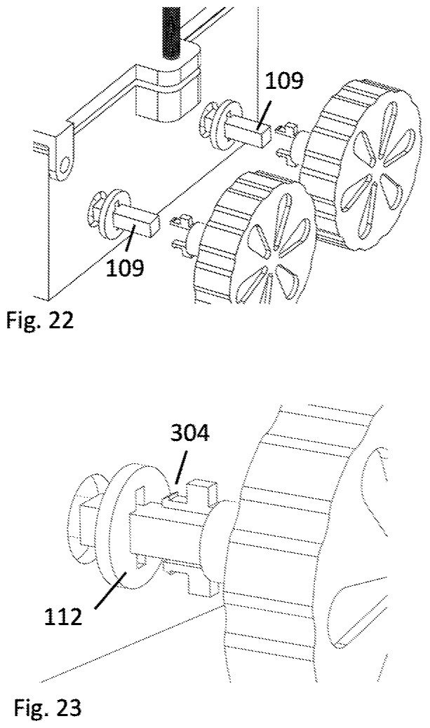

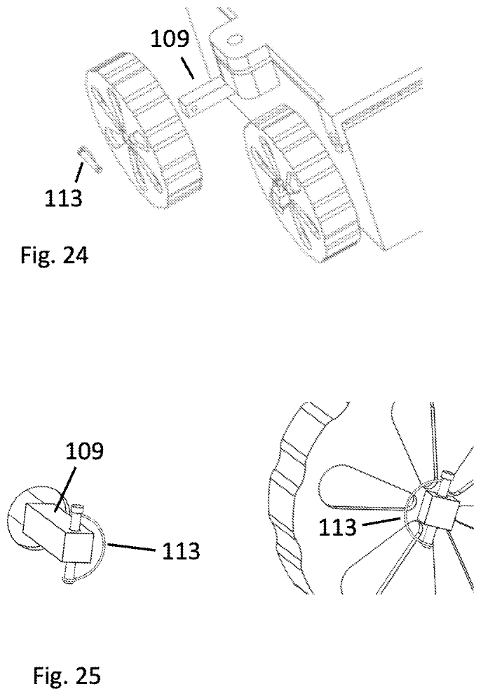

In one embodiment, the mobile wheel cart 300 is not needed, and the portable electronic box 200 couples with individual wheels directly. The individual wheels may couple and lock with the shaft of the wheel motor 109 with set screws 303 as shown in FIG. 19, FIG. 20 and FIG. 21. In another embodiment, the individual wheels may have male locking structure 304 to couple and lock with a female locking structure 112 on the shaft of wheel motor 109, as shown in FIG. 22 and FIG. 23. The roles of male locking structure 304 on the wheel and the female locking structures 112 on the shaft of wheel motor 109 may be exchanged. In one embodiment, a locked pin 113 may be used to couple and lock the shaft of wheel motor 109 with the individual wheel, as shown in FIG. 24 and FIG. 25.

So far the coupling of the portable electronic box 200 with individual wheel, mobile wheel cart 300, and the lawn mower body 101 refers to that the wheel motors 105 and battery 106 are inside the portable electronic box 200. In one embodiment, when the wheel motors 105 and battery are placed inside the lawn mower body 101 but outside the portable electronic box 200, the mobile wheel cart 300 may have another set of battery and wheel motors, and all previous stated coupling mechanisms among the portable electronic box 200, individual wheels, and the wheel motors 105 can be implemented similarly.

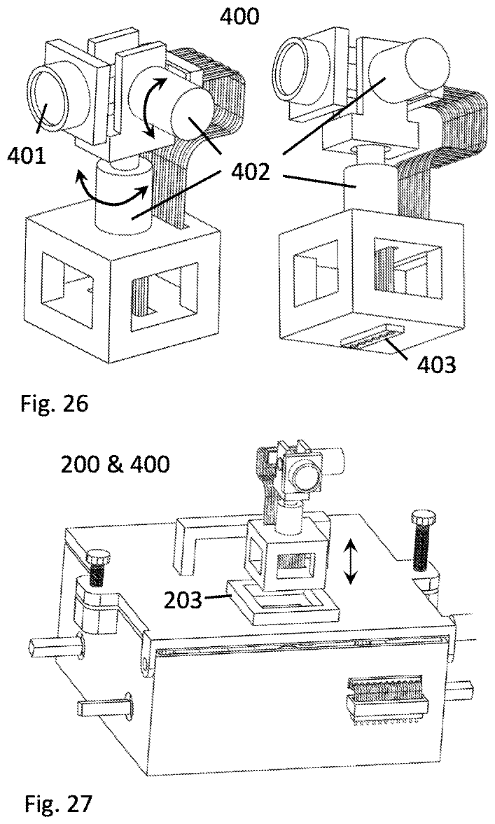

FIG. 26 illustrates a configuration of the surveillance camera module 400. The surveillance camera module 400 may include a surveillance camera 401, two camera motors 402, a camera module connector 403, and other electronic components. The two camera motors 402 may be used to control the viewing angle of the surveillance camera 401. One camera may be used to adjust the tilt angle and the other camera may be used to adjust the in-plane rotation angle. The surveillance camera 401 and camera motors 402 may be connected to the camera module connector 403 through electrical wires or cables as shown in the figure. In one embodiment, the camera module connector 403 may be placed at the bottom of the surveillance camera module 400 to couple and connect with the box coupling connector 203 on top of the portable electronic box 200 as shown in FIG. 27. The camera module connector 403 and the box coupling connector 203 provide not only mechanical but also electrical coupling such that the surveillance camera module 400 can be easily attached to or detached from the portable electronic box 200. In one embodiment, the surveillance camera module 400 may be fixed and coupled with portable electronic box 200, and it cannot be removed from the portable electronic box 200. A small surveillance camera module 400 may be built in and on the portable electronic box 200.

In one embodiment, the surveillance camera module 400 may be used to detect or monitor the objects, animals, people, and surrounding environments with advanced computer vision technology. The surveillance camera module 400 is electrically connected to the box circuit board 107 inside the portable electronic box 200 such that the CPU or microcontroller on the box circuit board 107 does appropriate image processing for the purpose of security surveillance. In one embodiment, the WIFI, wireless chips, or a radio device on the box circuit board 107 inside the portable electronic box 200 may pass the captured images or warning signals to users wirelessly. In another embodiment, with WIFI, wireless chips, internet IC, or radio device on the circuit board 107, users may control not only the moving of the mobile surveillance system 500 but also the viewing angle of surveillance camera 401 locally and remotely. With the disclosure, people may remotely maneuver the mobile surveillance system 500 to the desired locations, for example, inside one of the rooms indoors, front yard, or back yard, while they are at home or away from home.

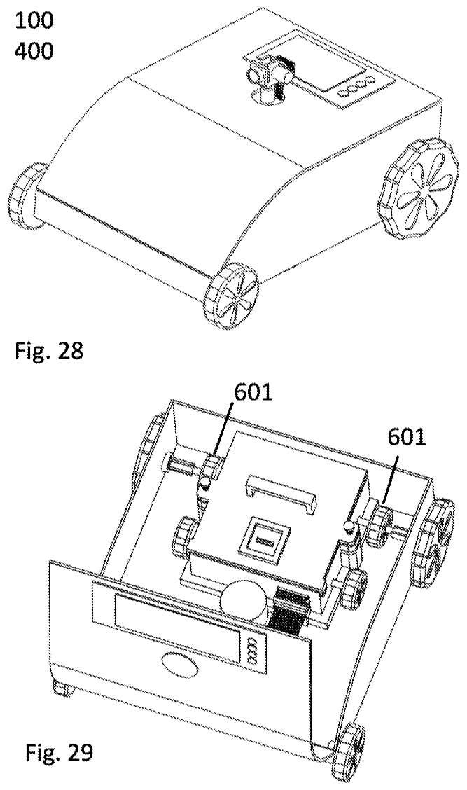

FIG. 27 illustrates the coupling of surveillance camera module 400 with the portable electronic box 200. The portable electronic box 200 may be placed on the base of mobile wheel cart 301 as shown in FIG. 18 or coupled with the individual wheels as shown in FIG. 21, FIG. 22, and FIG. 24 to function as a mobile surveillance system 500. In one embodiment, the surveillance camera module 400 may couple with the robotic lawn mower 100 as shown in FIG. 28, then the system is a mobile surveillance system 500 for outdoor use.

In one embodiment, the robotic lawn mower 100 may utilize an advanced computer vision technology to do the yard work smartly. The surveillance camera 401 may take images or videos of the ground such that the CPU or microcontroller on the box circuit board 107 in the portable electronic box 200 analyzes and collects the information of color, texture, pattern, structure, temperature, reflectivity, light emission, height, and so on. With the coupling of surveillance camera module 400, the robotic lawn mower 100 may implement computer vision technology to differentiate the grass and non-grass areas, and to determine a smart moving route and a best mowing method.

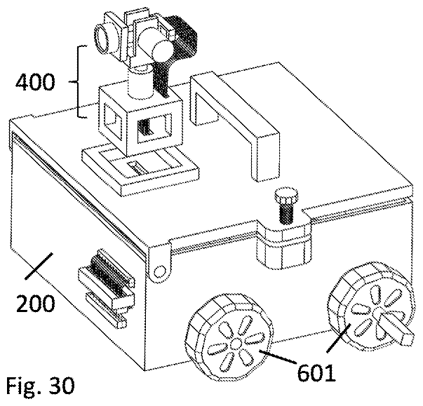

In one embodiment, a plurality of box wheels 601 couple with the portable electronic box 200 placed inside the lawn mower body 101, as illustrated in FIG. 29. The box wheels 601 and the portable electronic box 200 are small enough to be placed inside the lawn mower body 101 such that when the portable electronic box 200 is taken out of the lawn mower body 101, the portable electronic box 200 does not need the mobile cart 300 or other wheels, as demonstrated in FIG. 30. The box wheels 601 may couple with the portable electronic box 200 as an entity to be plugged in or out the lawn mower body 101 altogether. In one embodiment, the shaft of wheel motor 109 couples with the box wheels 601 placed inside the robotic lawn mower body 100 as well as with the wheels outside the robotic lawn mower body 101 as shown in the figures. When the portable electronic box 200, along with the box wheels, are taken out from the lawn mower body 101, the portable electronic box 200 couples with the surveillance camera module 400 to function as a standalone mobile surveillance system 500.

What is claimed is:

1. An interchangeable and dual-functional robot, comprising:
a robotic lawn mower body comprising a blade motor, a grass cutting blade and a mower circuit board; and
a portable electronic box comprising a battery, a plurality of wheel motors and a box circuit board; and
a surveillance camera module comprising a surveillance camera;
wherein said robotic lawn mower body comprising a recess to accommodate said portable electronic box, when said portable electronic box is in the recess of said robotic lawn mower body, said portable electronic box couples with said robotic lawn mower body to function as a robotic lawn mower; and
wherein when said portable electronic box is taken out of said robotic lawn mower body, said portable electronic box couples with said surveillance camera module to function as a mobile surveillance system.

2. The interchangeable and dual-functional robot of claim 1,
wherein when said portable electronic box is in the recess of said lawn mower body, said robotic lawn mower body comprising a fastener structure to couple with a matched fastener structure on said portable electronic box, a mower locking structure to couple with a box locking structure on said portable electronic box, or a magnet to couple with another magnet on said portable electronic box, such that when said portable electronic box is in the recess of said robotic lawn mower body, said portable electronic box is aligned, locked, and settled with said robotic lawn mower body mechanically;
wherein when said portable electronic box is in the recess of said lawn mower body, said robotic lawn mower body comprising a box electrical connector to couple with a mower body electrical connector on said lawn mower body electrically; and
wherein said portable electronic box couples with said lawn mower body mechanically and electrically to function as said robotic lawn mower.

3. The interchangeable and dual-functional robot of claim 1,
wherein when said portable electronic box is taken out said lawn mower body, said portable electronic box comprising a box camera connector to couple and connect with a camera module connector on said surveillance camera module, a box electrical connector to couple and connect with a mower body electrical connector such that said portable electronic box couples with said surveillance camera module mechanically and electrically to function as said mobile surveillance system.

4. The interchangeable and dual-functional robot of claim 1,
wherein when said portable electronic box is taken out of said robotic lawn mower body, said portable electronic box couples with a mobile wheel cart and said surveillance camera module to function as said mobile surveillance system; and
wherein said mobile wheel cart comprising a plurality of wheels.

5. The interchangeable and dual-functional robot of claim 1, further comprising a plurality of box wheels;
wherein said plurality of wheel motors in said portable electronic box include a plurality of shafts, each to couple with one of said plurality of box wheels with a set screw, said set screw is used to couple with said plurality of shafts of wheel motor to said plurality of said plurality of box wheels; and
wherein said portable electronic box, said surveillance camera module, and said plurality of box wheels are coupled together to function as said mobile surveillance system.

6. The interchangeable and dual-functional robot of claim 1, further comprising a plurality of box wheels;
wherein said plurality of wheel motors in said portable electronic box include a plurality of female locking structures, each to lock with a male structure on one of said plurality of box wheels, the roles of said male and female structures on said lock structures of said portable electronic box and said plurality of box wheels are interchangeable; and
wherein said portable electronic box, said surveillance camera module, and said plurality of box wheels are coupled together to function as said mobile surveillance system.

7. The interchangeable and dual-functional robot of claim 1, further comprising a plurality of box wheels;
wherein said plurality of wheel motors in said portable electronic box couples with each of said plurality of box wheels with a lock pin; and
wherein said portable electronic box, said surveillance camera module, and said plurality of box wheels are coupled together to function as said mobile surveillance system.

8. The interchangeable and dual-functional robot of claim 1,
wherein said portable electronic box couples with a plurality of box wheels placed in said robotic lawn mower body such that when said portable electronic box is taken out said lawn mower body, said portable electronic box does not need other wheels to function as said mobile surveillance system.

9. The interchangeable and dual-functional robot of claim 1,
wherein said portable electronic box comprising a CPU or microcontroller on said box circuit board;
wherein when said portable electronic box is in the recess of said lawn mower body, said CPU or microcontroller couples with electronic components on a mower circuit board in said lawn mower body to control the moving of said robotic lawn mower and said blade motor;
wherein when said portable electronic box is taken out of said lawn mower body, said portable electronic box couples with said surveillance camera module to function as said mobile surveillance system, the CPU or microcontroller on said box circuit board in said portable electronic box controls the moving of said mobile surveillance system and the viewing angle of said surveillance camera; and
wherein said CPU or microcontroller is dual-functional in the controlling of said robotic lawn mower and said mobile surveillance system.

10. The interchangeable and dual-functional robot of claim 9,
wherein said surveillance camera module coupled with said CPU or microcontroller on said box circuit board in said portable electronic box implements an advanced computer vision technology to take images or videos of a ground to analyze and collect the information of color, texture, pattern, structure, temperature, reflectivity, light emission, and grass height, to differentiate the grass and non-grass areas, and to determine a moving route and a mowing way.
